(19) United States
(12) Patent Application Publication
(10) Pub. No.: US 2003/0088481 A1
(43) Pub. Date: May 8, 2003

(54) Method and system for identifying purchasing cost savings

(75) Inventor: Eric Elias, Philadelphia, PA (US)

Correspondence Address: MORGAN LEWIS & BOCKIUS LLP, 1111 PENNSYLVANIA AVENUE NW, WASHINGTON, DC, 20004, US

(73) Assignee: Vert Tech LLC

(21) Appl. No.: 10/290,387

(22) Filed: Nov. 8, 2002

Related U.S. Application Data
(60) Provisional application No. 60/331,118, filed on Nov. 8, 2001.

(51) Int. Cl. G06F 17/60

(52) U.S. Cl. 705/26; 707/104.1

(57) ABSTRACT

A system for providing purchasing metrics that are used to identify purchasing costs savings opportunities. The system includes multiple databases, at least one processing component, and a reporting component. The databases receive and store purchasing data from numerous client applications. The processing component cleanses and categorizes data in at least one of the databases. The reporting component enables users to select and display reports on procurement sources, wherein the reports identify purchasing cost saving opportunities.

This application claims the benefit of U.S. Provisional Application No. 60/331,118, filed on Nov. 8, 2001 and incorporated by reference.

### FIELD OF THE INVENTION

The present invention relates to a system and method for providing process metrics to identify purchasing cost savings opportunities.

### BACKGROUND OF THE INVENTION

Corporations are typically made up of multiple departments that purchase materials from various external sources. It is therefore useful for corporations to have an overall view of procurement spending by viewing all or some of the materials purchased by the corporation and the sources from which these materials are purchased. This overall view may be used to identify cost saving opportunities for the corporations. It is also useful for the corporation to view information related to procurement spending based on certain predefined terms.

### SUMMARY OF THE INVENTION

The present invention relates to a system for providing purchasing metrics that are used to identify purchasing costs savings opportunities. The system includes multiple databases, at least one processing component, and a reporting component. The databases receive and store purchasing data from numerous client applications. The processing component cleanses and categorizes data in at least one of the databases. The reporting component enables users to select and display reports on procurement sources, wherein the reports identify purchasing cost saving opportunities.

Specifically in a preferred embodiment of the invention, the system includes a connector component, a normalization designer, an engine, and a report component. The connector component extracts purchasing data from external sources and deposits the purchasing data in a database. The normalization designer provides a set of tools for defining how data in the database will be cleansed and categorized. The engine uses definitions from the normalization designer to cleanse and categorize data in the database. The engine transmits cleanse and categorized data to a common data repository. The report component enables users to create reports based on information in the common data repository, wherein the reports enable users to analyze purchasing activities based on various factors.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

FIG. 1 illustrates a local area network (LAN) 100 that is configured to and identify purchasing cost savings;

FIG. 2 illustrates components of computer system 104;

FIG. 3 illustrates components in normalization designer 208;

FIG. 4 illustrates data elements for client applications and rules for specific elements to measure; and

FIG. 5 illustrates the steps implemented in the inventive system.

### DETAILED DESCRIPTION OF PREFERRED EMBODIMENTS OF THE INVENTION

Reference will now be made in detail to a preferred embodiment of the present invention, an example of which is illustrated in the accompanying drawings. The present invention described below extends the functionality of the inventive system and method for identifying purchasing cost savings.

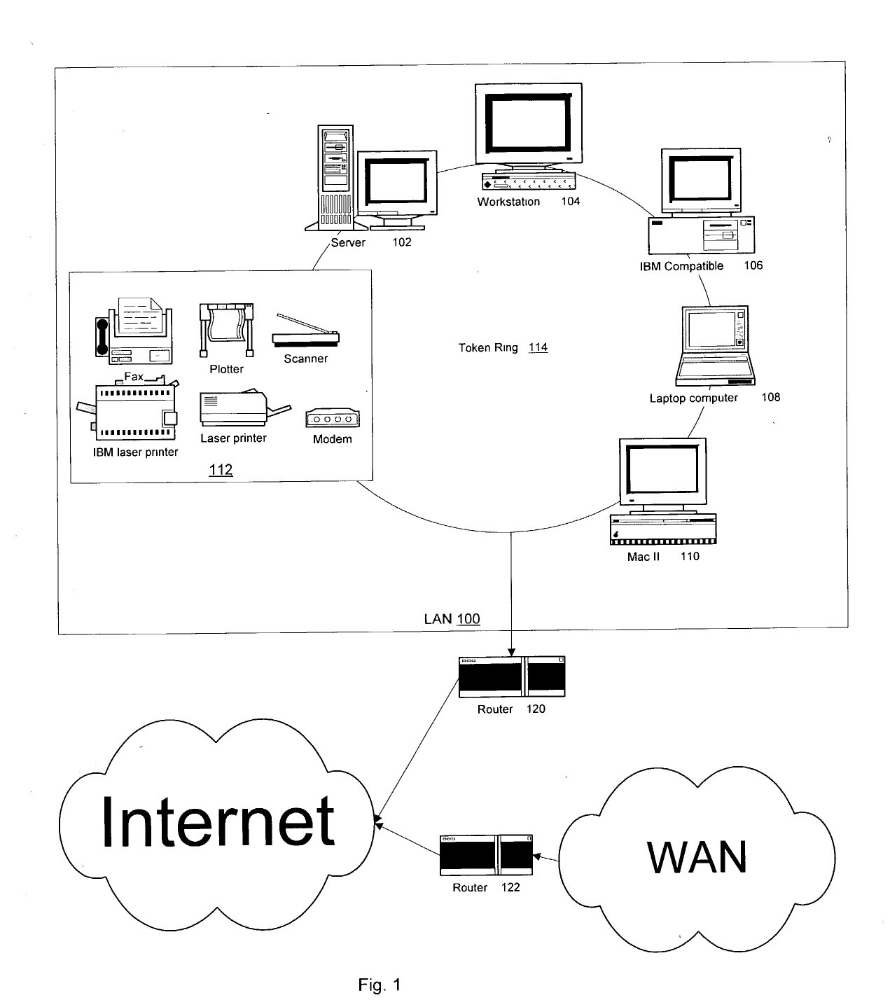

FIG. 1 illustrates a local area network (LAN) 100 that is configured to analyze and identify purchasing cost savings. LAN 100 comprises a server 102, four computer systems 104-110, and peripherals, such as printers and other devices 112, that may be shared by components on LAN 100. Computer systems 104-110 may serve as clients for server 102 and/or as clients and/or servers for each other and/or for other components connected to LAN 100. Components on LAN 100 are preferably connected together by cable media, for example copper or fiber-optic cable, and the network topology may be a token ring topology 114. It should be apparent to those of ordinary skill in the art that other media, for example wireless media, such as optical and radio frequency, may also connect LAN 100 components. It should also be apparent that other network topologies, such as Ethernet, may be used.

According to the invention, LAN 100 is connected to the Internet and may be connected to other LANs or Wide Area Networks (WAN). Hence some components of LAN 100 are preferably Web-enabled. The computer processor for executing the inventive system and method, for example server 102 and/or computer systems 104-110, include electronic storage media, such as disks, for storing programming code and data structures used to implement the inventive method and outputs therefrom. The invention uses a computer system, for example computer system 104, to implement an inventive application for gathering detailed financial information from non-depository institutions and calculating risk exposure from the financial information. Note that any computer system may be configured to implement the inventive method and computer system 104 is only used for exemplary purposes.

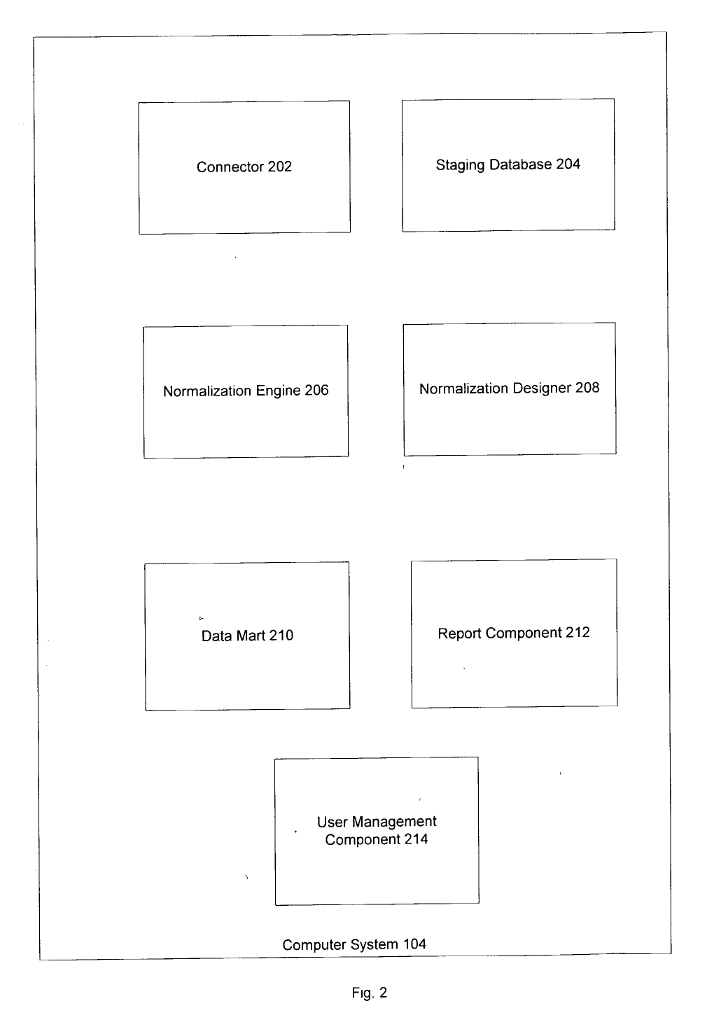

Computer system 104 includes a web interface through which users can access various reporting and administration functions. FIG. 2 illustrates components of computer system 104. Computer system 104 includes a connector 202, a staging database 204, a normalization engine 206, a normalization designer 208, a data mart 210, a report component 212 and a user management component 214. Connector 202 extracts purchasing data associated with other client applications from various sources and deposits the data into a raw data table in staging database 204. Staging database 204 includes the raw data table that stores data imported from client applications and tables that are used to stage cleansing, classification, and mapping activities on the data in the raw data table. Normalization designer 208 provides a set of tools for cleansing and categorizing data in the raw data table. Normalization engine 206 uses information entered into normalization designer 208 to process data in the raw data table. After processing the data in the raw data table, normalization engine 206 forwards the data to data mart 210 which is designed to enable multi-dimensional data analysis. Report component 212 enables users to select and display reports on procurement sources. User management component 214 controls access to reports created by report component 212. By extracting data from existing customer applications and categorizing the data into a common data repository, the inventive system enables creation reports to analyze purchasing activities based on various factors, such as time, supplier, organization and material specifications.

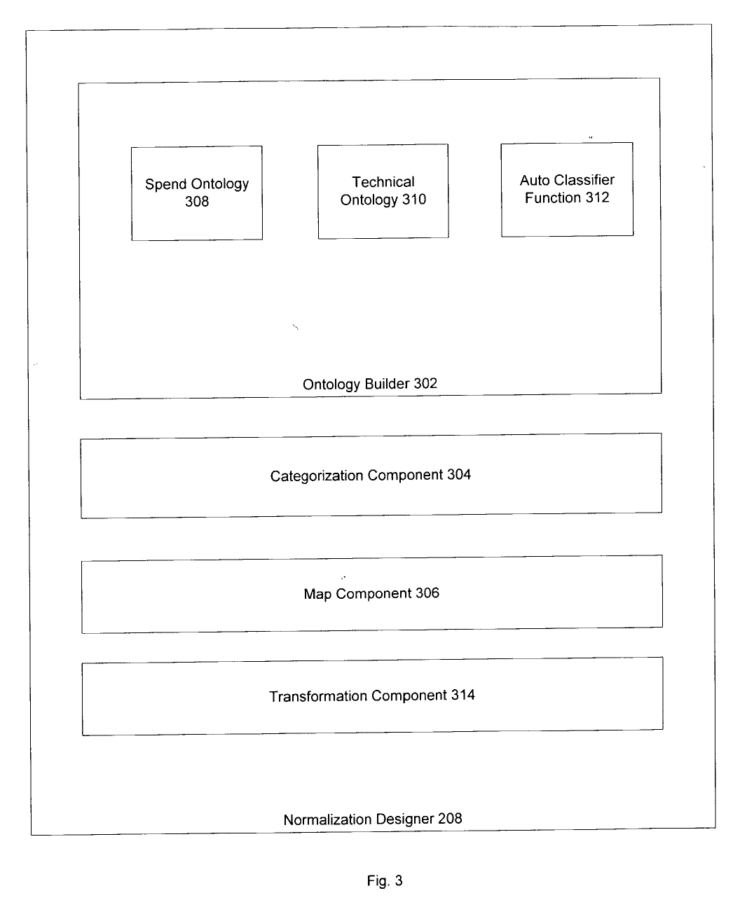

Prior to processing data in the system, a user accesses tools in normalization designer 208 to define how to cleanse, i.e., correct and remove errors, and classify purchasing data extracted from client applications. FIG. 3 illustrates components in normalization designer 208. Normalization designer 208 includes an ontology builder 302, a categorization component 304 and a map component 306. The ontology builder creates and manages a spend ontology 308 and a technical ontology 310. Each ontology in normalization designer 208 is a representation of business hierarchies associated with spending activities, along with descriptions, attributes and relationships of hierarchy members. Technical ontology 310 is a vendor independent classification of purchased materials and spend ontology 308 describes the internal purchasing specifications. Ontology builder 302 also includes an auto classifier function 312 for automatically grouping the raw data table records by field values. Categorization component 304 maps groups classified by auto classifier function 312 against spend ontology 308. Thereafter, map component 306 matches spend ontology 308 members against technical ontology 310.

After creating the ontologies in ontology builder 302, the user defines cleansing rules for correcting and removing errors from data extracted from client applications. Normalization designer 208 applies functoids, i.e., small data processing functions written in simple scripting language, to perform data cleansing on all records in the raw data table in staging database 204 (FIG. 2). Normalization designer 208 also includes tools for classifying cleansed data against an analysis ontology. This enables normalization designer 208 to associate records with consistent terminology and hierarchical structure.

Normalization designer 208 includes a transformation component 314 which modifies and manipulates data from multiple sources into a common format. The transformed data includes values extracted from these sources and calculations based on data contents.

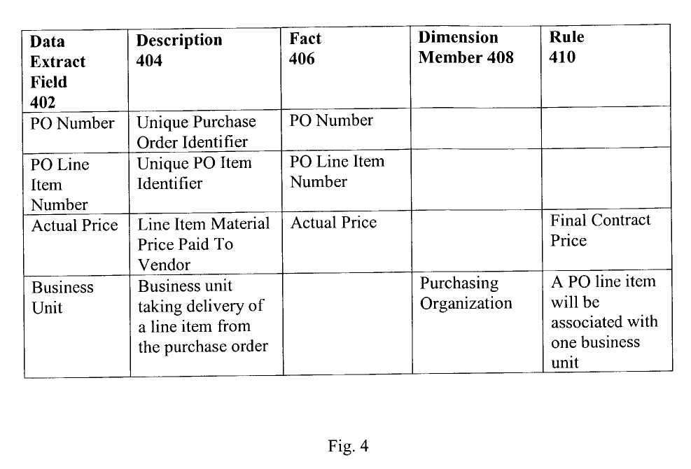

In a preferred embodiment of the invention shown in FIG. 2, connector 202 extracts client application data relating to purchasing activities from flat files, databases, and other data sources. Connector 202 may be executed by a batch process scheduler. As is apparent to one of ordinary skill in the art, connector 202 may also be executed dynamically or through other means. Connector 202 includes functions that combine data extracted from multiple data sources into a consolidated export table. Connector 202 deposits the consolidated export table into the raw data table. Data in database 204 is organized by dimensions and measures. Dimensions define hierarchies that convey how purchasing is organized and measures define fact values about money, time, and people associated with dimension members. Computer system 104 uses normalization designer 208 to collect information that associates clients' business relationships to dimensions and defines rules to convert raw client data into measures. FIG. 4 illustrates data elements from client applications and rules for mapping specific elements to measures.

Each row in FIG. 4 includes a data extract field 402, a description field 404, a fact field 406, a dimension member field 408 and a rule field 410. Data extract field 402 identifies data extracted from client applications. Description field 404 describe data extract field 402. Fact field 406 define values associated with dimension member field 408 which defines a hierarchy that convey how purchasing is organized in an organization.

Normalization engine 206 applies normalization activities defined through normalization designer 208 on the data in the raw data table. Normalization engine 206 specifically applies the cleansing, classification and transformation rules defined in normalization designer 208, manages normalization database operations and initiates the processes to populate data mart 210. Normalization engine 206 preferably employs a workflow controller to configure the sequence of normalization activities, populate data mart 210 with normalized extracted data, and manage definitions and contents of business dimensions that enable on-line analytical processing. Workflow controller may be executed by a batch process or dynamically.

Data mart 210 is a primary data repository for all normalized enterprise data. The data structure in data mart 210 is designed to enable on-line analytical processing, thereby enabling dynamic analysis of multi-dimensional data. Data from data mart 210 is transmitted to a data store that enables the user to obtain a pre-aggregated view of business metrics, such as price and quantity, mapped to each level of business hierarchy, such as time, organization, material specification and supplier. Thereafter, the report component 212 enables the user to select and display reports on data in the data store based on procurement sources. Report component 212 enables the user to create, from queries against the data source, pre-defined and ad-hoc reports that display procurement spending. User management component 214 controls access to reports and records generated by report component 212.

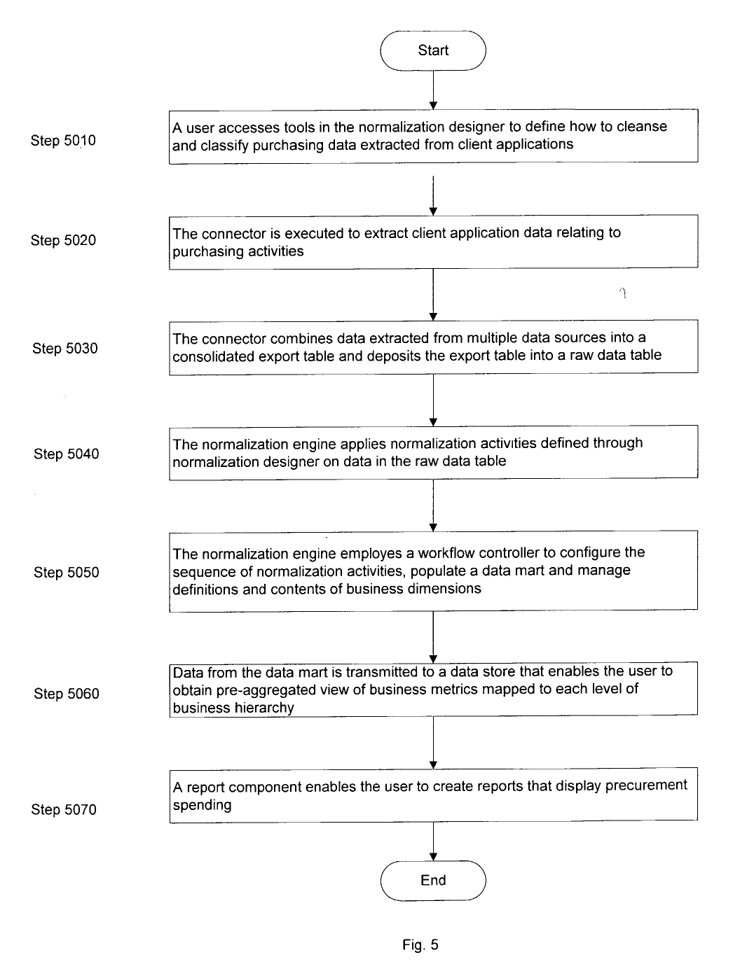

FIG. 5 illustrates the steps implemented in a preferred embodiment of the invention. In Step 5010, a user accesses tools in normalization designer 208 to define how to cleanse and classify purchasing data extracted from client applications. In Step 5020, connector 202 is executed by a batch process to extract client application data relating to purchasing activities from flat files, databases, and other data sources. In Step 5030, connector 202 combines data extracted from multiple data sources into a consolidated export table and deposits the consolidated export table into the raw data table. In Step 5040, normalization engine 206 applies normalization activities defined through normalization designer 208 on the data in the raw data table. In Step 5050, normalization engine 206 employs a workflow controller to configure the sequence of normalization activities, populate data mart 210 with normalized extracted data, and manage definitions and contents of business dimensions that enable on-line analytical processing. In Step 5060, data from data mart 210 is transmitted to a data store that enables the user to obtain a pre-aggregated view of business metrics mapped to each level of business hierarchy. In Step 5070, report component 212 enables the user to create predefined and ad-hoc reports that display procurement spending.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for providing purchasing metrics that are used to identify purchasing costs savings opportunities, the system comprising:
a plurality of databases for receiving and storing purchasing data from a plurality of applications,
at least one processing component for cleansing and categorizing data in at least one of the plurality of databases;
a reporting component for enabling users to select and display reports on procurement sources, wherein the reports identify purchasing cost saving opportunities; and
means for receiving purchasing data from a plurality of applications, for cleansing and categorizing the data and forwarding the categorized data to a common data repository, wherein the reports are created against the common data repository to analyze purchasing activities based on various factors.

2. A system for providing purchasing metrics that are used to identify purchasing costs savings opportunities, the system comprising:
a connector component for extracting purchasing data for external sources and depositing the purchasing data in a database;
a normalization designer that provides a set of tools for defining how data in the database will be cleansed and categorized;
an engine for using definitions from the normalization designer to cleanse and categorize data in the database, wherein the engine transmits cleansed and categorized data to a common data repository; and
a report component for enabling users to create reports based on information in the common data repository, wherein the reports enable users to analyze purchasing activities based on various factors.

3. The system of claim 2, wherein the connector component extracts purchasing data from client applications and deposits the purchasing data in a table in the database.

4. The system of claim 2, wherein the connector component is executed by a batch process.

5. The system of claim 2, wherein data in the database is organized by dimensions and measures.

6. The system of claim 2, wherein the normalization designer further comprises:
an ontology builder that creates and manages a plurality of ontologies, the ontology builder includes an auto classifier function that automatically groups records in the database by field values;
a categorization component that maps groups classified by the auto classifier function against a spend ontology that describes internal purchasing specifications;
a map component that matches the spend ontology member against a technical ontology;
a transformation component that modifies and manipulates data in the database into a common format; and
means for enabling a user to define cleansing rules on data in the database and for classifying cleansed data against an analysis ontology, wherein the classification enables the normalization designer to associated records with consistent terminology and hierarchical structure.

7. The system of claim 6, wherein the normalization designer applies functoids to the database to cleanse data in the database.

8. The system of claim 2, wherein the engine applies cleansing, classification, and transformation rules defined in the normalization designer, manages operations in a normalization database, and initiates a process to populate the common data repository.

10. The system of claim 2, wherein the engine employs a workflow controller to configure a sequence of normalization activities, to populate the common data repository with normalized extracted data, and to manage definitions and contents of business dimensions that enable on-line analytical processing.

11. The system of claim 2, wherein data from the common data repository is transmitted to a data store for enabling the user to obtain a pre-aggregated view of business metrics that are mapped to each level of business hierarchy.

12. A method for providing purchasing metrics that are used to identify purchasing costs savings opportunities, the method comprises the steps of:
accessing tools to define how to cleanse and classify purchasing data that is extracted from a plurality of sources;
extracting purchasing data from a plurality of sources;
combining the extracted data into an export table that is deposited in a database;
applying normalization activities for cleansing and classifying the purchasing data in the database; and
transmitting normalized data to a common data repository, wherein users may obtain pre-aggregated views of business metrics mapped to each level of a business hierarchy from the common data repository to identify purchasing costs savings opportunities.

13. The method of claim 12, wherein the step of applying further comprises the step of employing a workflow controller to configure the sequence of normalization activities, to populate the common data repository with normalized data and to manage definitions and contents of business dimensions.

14. A system for providing purchasing metrics that are used to identify purchasing costs savings opportunities, the system comprising:
means for accessing tools to define how to cleanse and classify purchasing data that is extracted from a plurality of sources;
means for extracting purchasing data from a plurality of sources;
means for combining the extracted data into an export table that is deposited in a database;
means for applying normalization activities for cleansing and classifying the purchasing data in the database; and
means for transmitting normalized data to a common data repository, wherein users may obtain pre-aggregated views of business metrics mapped to each level of a business hierarchy from the common data repository to identify purchasing costs savings opportunities.
